(19) United States
(12) Patent Application Publication
(10) Pub. No.: US 2011/0108380 A1
(43) Pub. Date: May 12, 2011

(54) DISC BRAKE COLLIPER SUPPORT

(76) Inventor: Allan Martin James, Victoria (AU)

(21) Appl. No.: 12/988,467

(22) PCT Filed: Apr. 17, 2009
(86) PCT No.: PCT/AU2009/000476

§ 371 Date: Jan. 4, 2011

(30) Foreign Application Priority Data
Apr. 18, 2008 (AU) 2008901954

(51) Int. Cl. F16D 65/28

(52) U.S. Cl. 188/219.1

(57) ABSTRACT

A disc brake calliper support including a calliper mounting for coupling the support relative to a disc brake calliper, an anchor mounting for anchoring the support relative to an axis about which the disc rotates, and a support structure between the calliper mounting and the anchor mounting, wherein the support structure is adapted to support the calliper relative to the axis against deflection out of a plane of the disc during application of the disc brake, and wherein the support structure allows linear movement between the calliper mounting and the anchor mounting to facilitate operation of the disc brake.

### FIELD OF THE INVENTION

This invention relates to a support for a disc brake calliper, and more particularly, but not exclusively, to a support for a disc brake calliper of a vehicle for reducing accelerated wear of braking components.

### BACKGROUND OF THE INVENTION

It is well known to provide disc brakes on vehicles, and there has been a move toward the use of disc brakes over recent years as they are considered to provide improved braking performance when compared to drum brakes. Disc brakes are now standard equipment on most performance cars, and also on passenger cars, at least on the front wheels, and motorbikes.

However, the use of disc brakes on heavy vehicles such as road transport vehicles and the like has been slow, and many road transport vehicle operators prefer to operate vehicles having drum brakes rather than disc brakes, owing to maintenance costs. The applicant has determined that it would be beneficial for there to be provided an advancement which would reduce the maintenance costs of disc brakes, particularly when used on large road transport vehicles.

Examples of the present invention seek to provide a support for a disc brake calliper which overcomes or at least alleviates one or more disadvantages associated with previous disc brake systems.

### SUMMARY OF THE INVENTION

In accordance with one aspect of the present invention, there is provided a disc brake calliper support including a calliper mounting for coupling the support relative to a disc brake calliper, an anchor mounting for anchoring the support relative to an axis about which the disc rotates, and a support structure between the calliper mounting and the anchor mounting, wherein the support structure is adapted to support the calliper relative to the axis against deflection out of a plane of the disc during application of the disc brake, and wherein the support structure allows linear movement between the calliper mounting and the anchor mounting to facilitate operation of the disc brake.

Preferably, the calliper mounting is in the form of a calliper mounting bracket which is fastened to the calliper at a plurality of locations on the calliper. More preferably, the calliper mounting bracket includes a pair of apertures for fastening to the a pair of bolts at the rear of the calliper.

Preferably, the anchor mounting is adapted for securing the support to an axle associated with the disc brake. In one form, the disk brake calliper is for braking a wheel of a vehicle, and the anchor mounting is adapted for securing the support to an axle of the wheel. More preferably, the anchor mounting includes an anchor mounting bracket for clamping around the axle.

In a preferred form, the support structure includes a sliding arrangement which provides lateral support to prevent said deflection of the calliper relative to the axis out of the plane of the disc during application of the disc brake, and the sliding arrangement permits longitudinal sliding of the calliper mounting relative to the anchor mounting to allow said linear movement between the calliper mounting and the anchor mounting to facilitate operation of the disc brake.

Preferably, the calliper mounting bracket includes a guide member extending substantially parallel to said axis about which the disc rotates, and the anchor mounting bracket includes a sliding member arranged to slide along a length of the guide member. More preferably, the guide member is in the form of a pin and the sliding member is in the form of a guided ring mounted about the pin.

In one form, the anchor mounting bracket is fastened to a suspension assembly which is fixed relative to the axis.

Preferably, the pin is located radially further from the axis than is the calliper housing from said axis.

In a preferred example, the pin is located to one side of a central plane which is coincident with the axis and which bisects the calliper housing.

Preferably, the support structure includes an arm fixed to the calliper mounting, and a pair of stops fitted to the anchor mounting and spaced in the direction of the axis, arranged such that in use the arm is located between the stops with the stops abutting either side of the arm to resist said deflection of the calliper. More preferably, the stops are provided with bearings to facilitate rolling of the stops along the arm to facilitate sliding movement of the calliper mounting relative to the anchor mounting during operation of the disc brake. Even more preferably, the stops are rotationally mounted to a pivot portion of the anchor mounting, and the pivot portion is pivotally mounted to the anchor mounting bracket. In one form, each of the stops has a profiled rolling surface, and the arm is correspondingly profiled to restrict movement of the arm away from the rolling surface.

Preferably, the support provides a preload bias to the calliper mounting in an opposite sense to said deflection. More preferably, the preload bias is applied by elastically bending the arm by adjusting the location of the stops. Even more preferably, the location of the stops is adjusted by pivoting the pivot portion relative to the anchor mounting bracket.

It is preferred that the support provides adjustment of the preload bias. The support may be adjustable by operation of an adjustment mechanism which is operable to a release condition in which the calliper mounting is released from the anchor mounting to facilitate servicing of the disk brake calliper. In one form, the adjustment mechanism is in the form of a threaded fastener which is adjustable for tightening a connection between the anchor mounting bracket and the pivot portion.

### BRIEF DESCRIPTION OF THE DRAWINGS

The invention is described, by way of non-limiting example only, with reference to the accompanying drawings in which:

FIG. 1 is a diagrammatic top view of a disc brake showing forces acting on the calliper during operation of the disc brake;

FIG. 2 is a diagrammatic top view of a disc brake showing pressure points on pads of the disc brake during operation;

FIG. 3 is a top view of pads of the disc brake shown in FIG. 2;

FIG. 4 is a top view of the disc brake showing warping of a disc of the disc brake during operation of the brake;

FIGS. 5a to 5e show progressive stages of installation of a disc brake calliper support in accordance with an example of the present invention;

FIG. 6 shows a perspective view of a disc brake calliper support, similar to the one shown in FIG. 5e, in a release condition;

FIG. 7 is a perspective view of the disc brake calliper support of FIG. 6, shown in an active condition;

FIG. 8 shows diagrammatic top and end views of an arm of the disc brake calliper support, held between stops;

FIG. 9 is a diagrammatic top view of a disc brake calliper support in accordance with an alternative example of the present invention;

FIG. 10 is a diagrammatic top view of a disc brake calliper support in accordance with a further alternative example of the present invention;

FIGS. 11a to 11c are perspective, front and top views of a two part support shown fitted to an existing disc brake assembly;

FIGS. 12a to 12c are perspective, front and top views of an anchor mounting bracket of the support of FIGS. 11a to 11c; and

FIGS. 13a to 13d are perspective, front, top and end views of a calliper mounting bracket of the support shown in FIGS. 11a to 11c.

### DETAILED DESCRIPTION

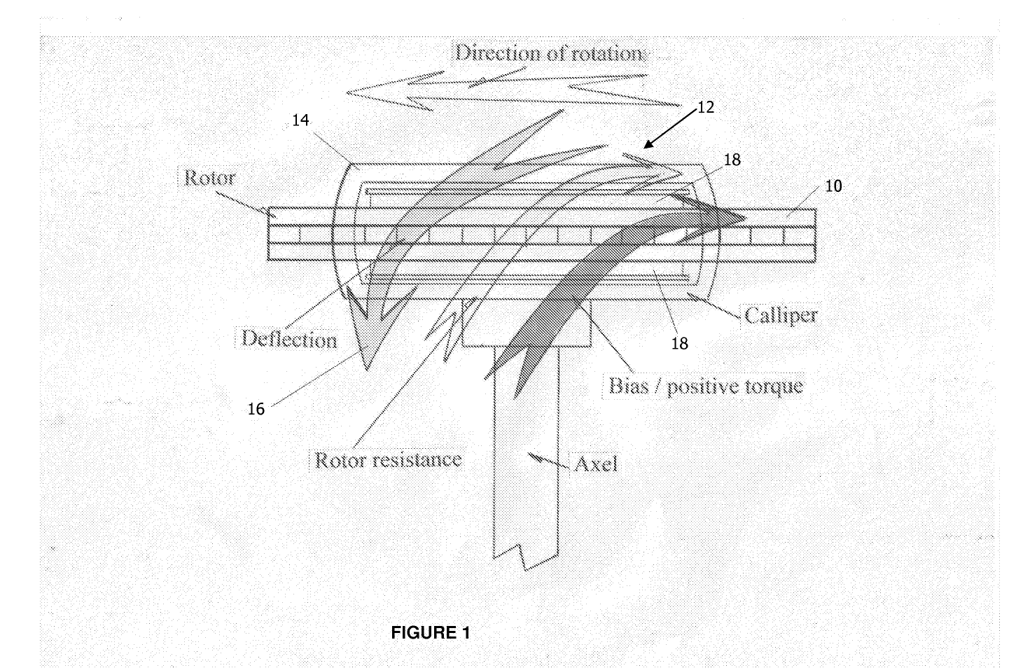

With reference to FIG. 1 of the drawings, the applicant has determined that present disc brake systems have a problem in that forces acting on a disc 10 of a disc brake 12 tend to drag a calliper 14 of the disc brake 12 along with the disc 10, such that the calliper 14 deflects in the direction shown by arrow 16. This deflection is particularly relevant where high stopping forces are required, such as with heavy road transport vehicles, and accelerated wear of components due to the deflection have resulted in inflated maintenance costs which, in turn, have resulted in the reluctance of road transport vehicle operators to move from drum brake systems to disc brake systems.

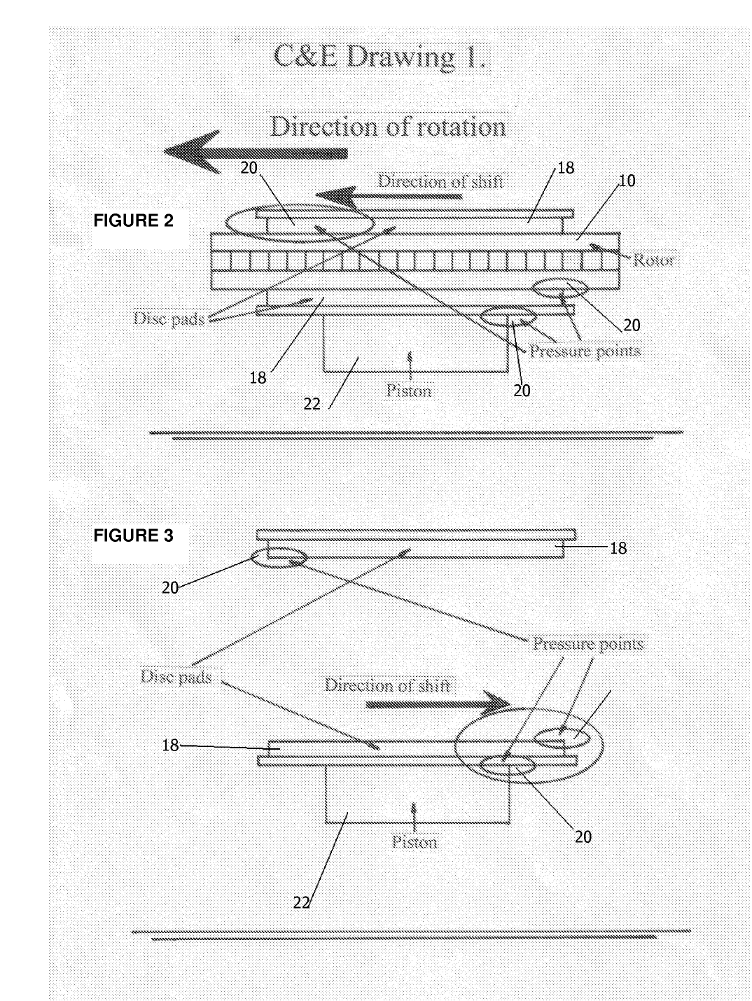

The applicant has identified that the actual cost of maintenance for a heavy vehicle fitted with disc brakes is far higher than the recommended maintenance costs, owing to this accelerated wear. The accelerated wear effects the disc rotors 10, pads 18, and callipers 14. With reference to FIGS. 2 to 4, the applicant has determined that deflection of the calliper 14 due to the disc brake pads 18 being drawn in the direction of rotation by the disc 10 during operation of the disc brake 12 is the cause of accelerated wear and is an inherent design flaw in disc brakes. The deflection of the calliper 14 causes pressure points 20 at edges of the disc brake pads 18, leading to premature wear of the disc brake pads 18.

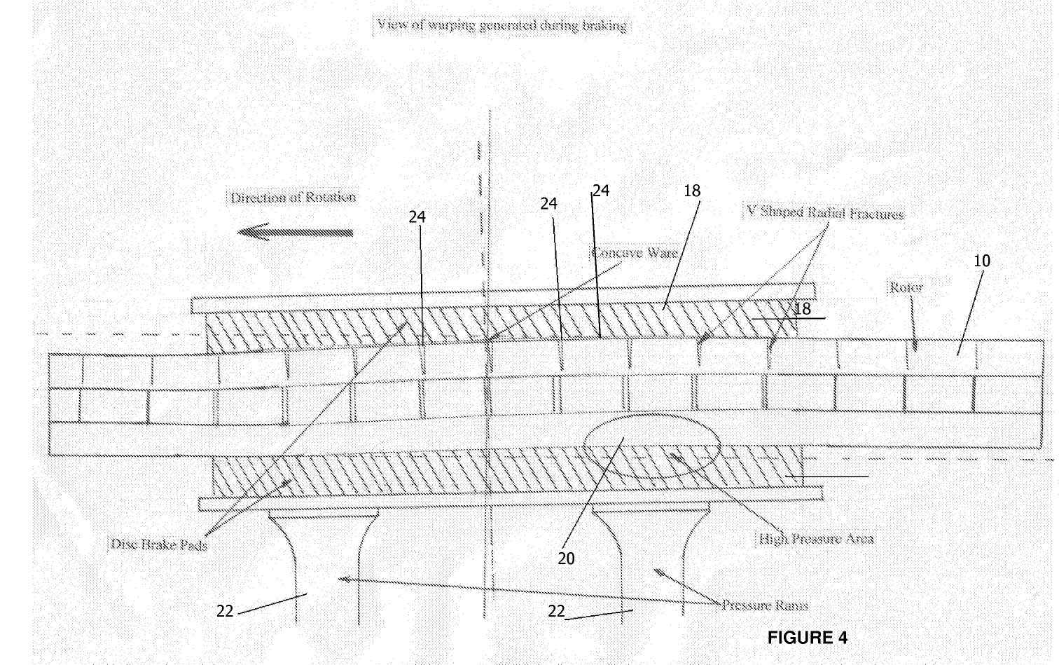

With reference to FIG. 4 in particular, enough force is generated during operation of the disc brake 12 that sliding pins of the calliper 14 may seize, and the calliper 14 may be unable to equalise braking pressure on both sides of the disc brake pads 18. As a result, the braking force generated by the piston 22 is dedicated to the pad 18 on the piston side of the calliper 14, producing a high pressure area generating high temperatures, and a significant temperature variation between the two sides of the ventilated disc rotor 10. This temperature variation may result in expansion and flexing of the disc 10, and radial fractures 24 that segment the disc 10 may form. Consequentially, when the calliper 14 is drawn in the direction of rotation of the disc 10, twisting may be transferred by bearings of the disc brake 12, leading to premature bearing failure.

In addition to causing problems of accelerated wear, deflection of the calliper 14 may also increase rolling resistance and therefore fuel consumption of the vehicle.

It has been determined by the applicant that the problem may be solved by reducing the amount of braking torque being transferred to the axle of the vehicle through slide pins and a mounting bracket of the calliper 14. The disc brake calliper support 26 in accordance with examples of the invention generates a bias for positive torque in an opposite sense to the deflection, thus neutralising the deflection as the opposing forces cancel. Furthermore, the disc brake calliper support 26 allows the forces generated during braking to be transferred to the axle via an alternative path which provides increased resistance to deflection of the calliper 14.

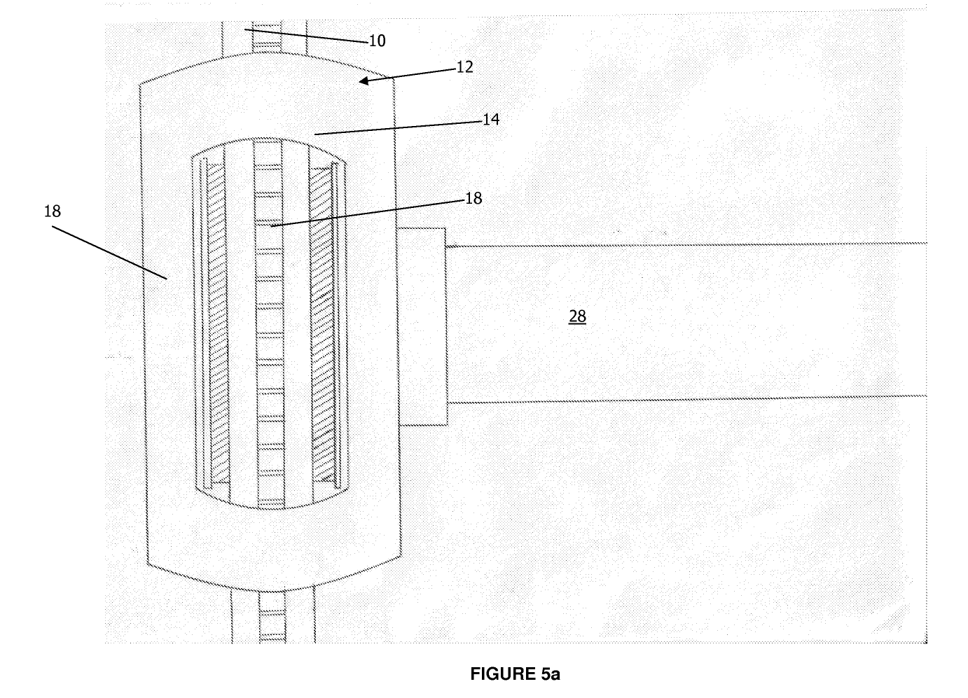

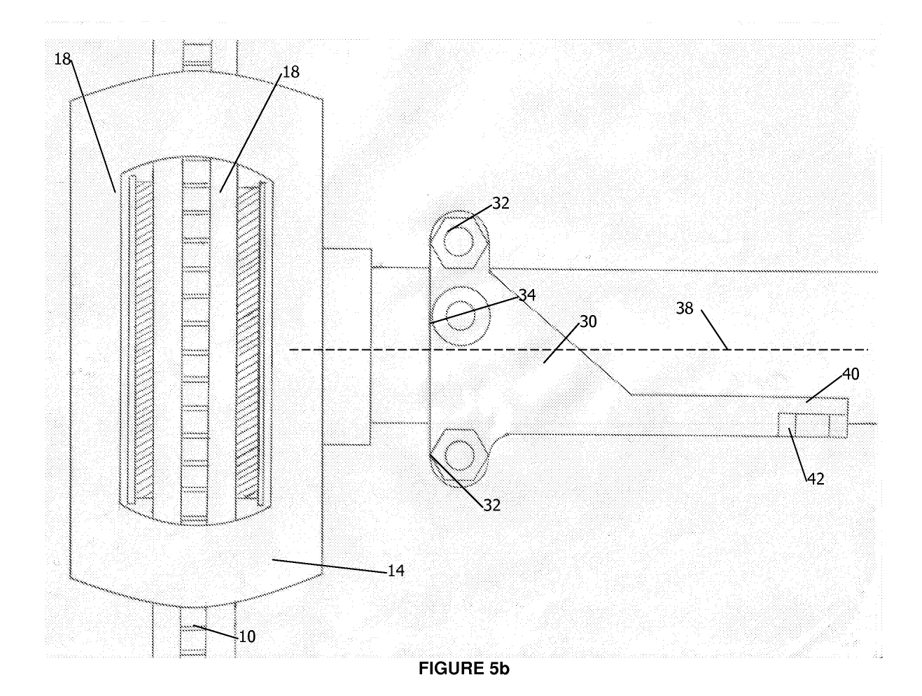

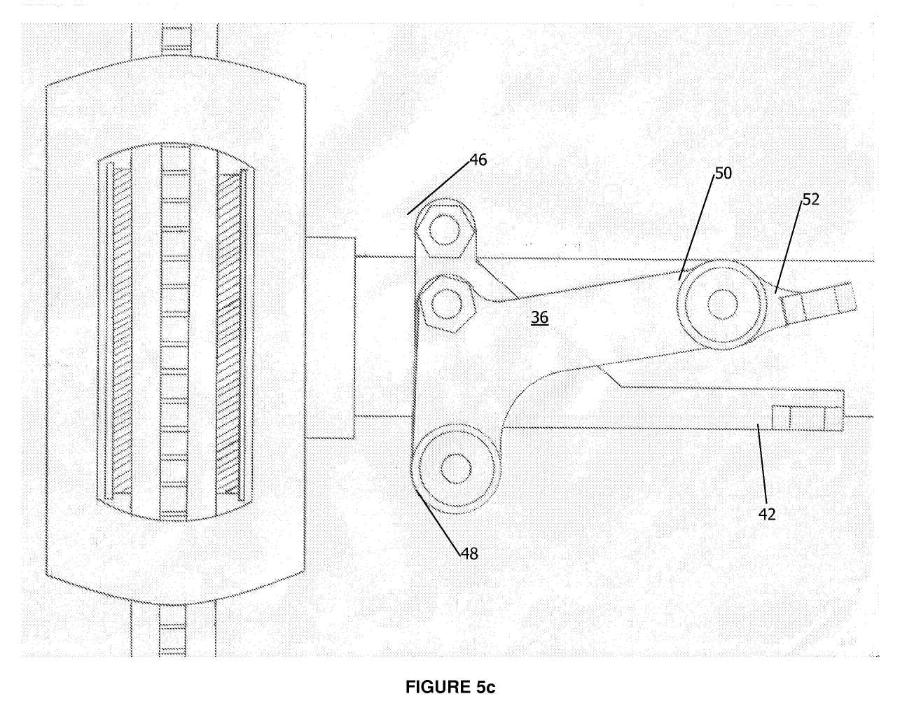

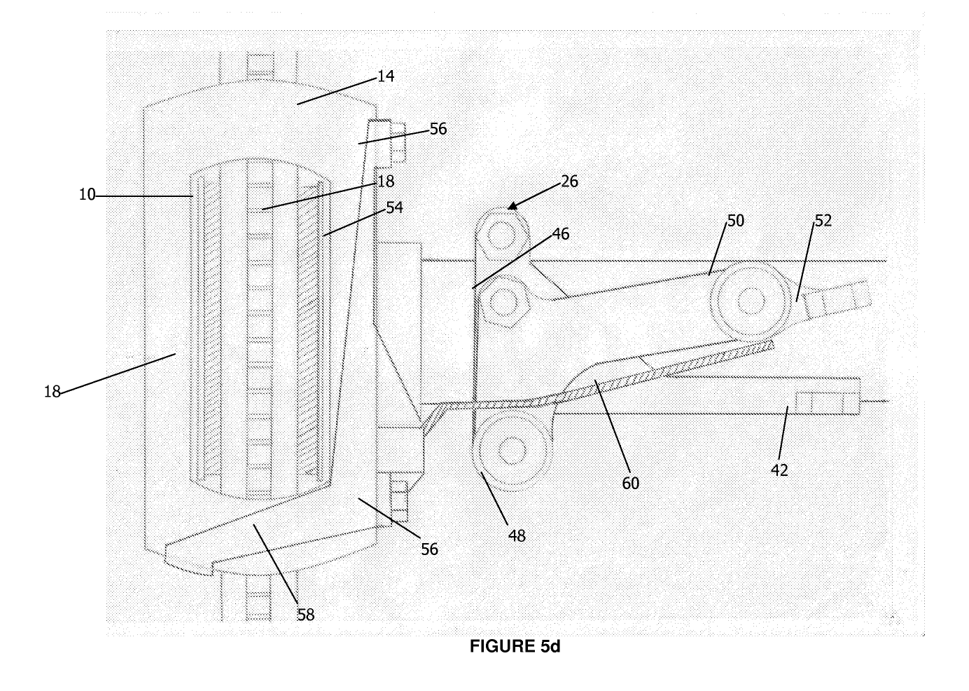

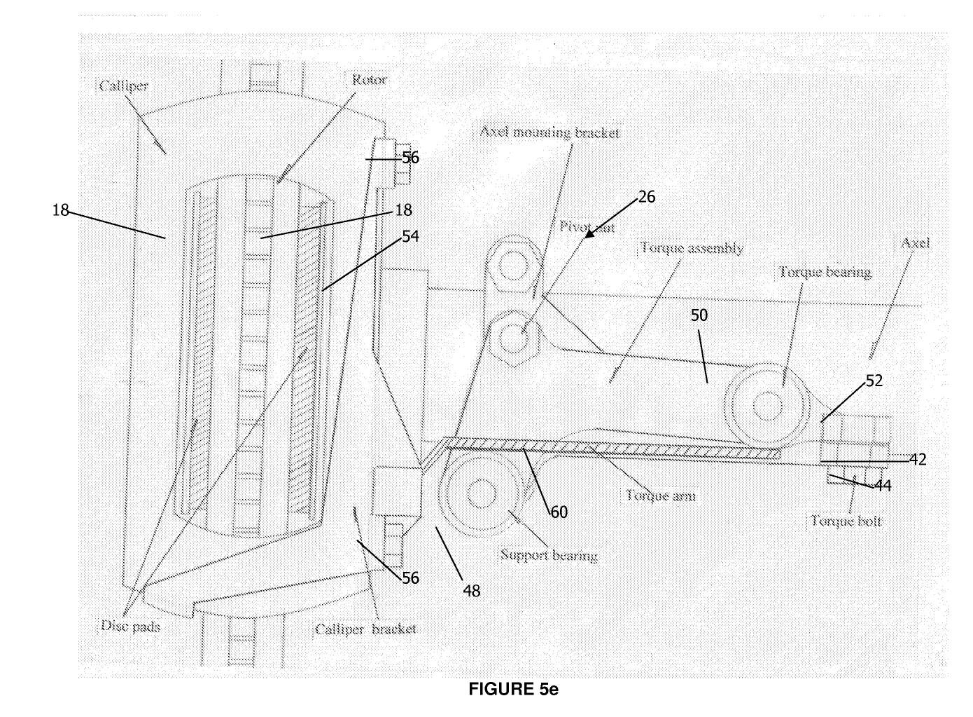

FIGS. 5a to 5e show progressive installation of a disc brake calliper support 26 to a disc brake 12 and axle 28. More particularly, with reference to FIG. 5a, there is shown a disc brake 12 fitted relative to an axle 28 of a vehicle, where the disc brake 12 is used to brake a wheel of the vehicle. The disc brake 12 comprises calliper 14, disc brake pads 18, and ventilated disc 10.

FIG. 5b shows an anchor mounting bracket 30 which is fitted around the axle 28 by way of clamping bolts 32. The anchor mounting bracket 30 has a pivot 34 to which a pivot portion 36 is mounted (see FIG. 5c). The anchor mounting bracket 30 extends substantially parallel to an axis 38 of the axle 28 to an inner end 40 which has an aperture 42 for receiving a fastener 44.

The pivot portion 36 is fitted to the pivot 34 by way of a pivot fastener 46, and is generally L-shaped, with stops 48, 50 at either end. More particularly, the pivot portion 36 has a first stop 48 at an end near the calliper 14, and a second stop 50 at an end away from the calliper 14. An aperture 52 is provided beyond the second stop 50 for locating the pivot portion 36 relative to the anchor mounting bracket 30.

With reference to FIG. 5d, a calliper mounting bracket 54 is fastened to a rear of the calliper 14, at a pair of fastening bolts 56 at either side of the calliper 14, and has a outward protruding bracket portion 58 which holds a side of the calliper 14 toward a front of the vehicle. Integral to the calliper mounting bracket 54 is an arm 60 which extends inwardly between the stops 48, 50. As can be seen, the arm 60 is located with the first stop 48 on a forward side of the arm 60, and with the second stop 50 to a rearward side of the arm 60. In this way, as the pivot portion 36 is pivoted about the pivot 34 by way of tightening the fastener 44, a preload bias is applied to the calliper mounting bracket 54. With reference to FIGS. 5d and 5e, the pivot portion 36 is pivoted about the pivot 34 such that the apertures 42 and 52 are brought together where they are fastened by the fastener 44, resulting in elastic bending of the arm 60.

Accordingly, the disc brake calliper support 26 includes a calliper mounting in the form of the calliper mounting bracket 54 for coupling the support 26 relative to the disc brake calliper 14, and an anchor mounting in the form of the anchor mounting bracket 30 for anchoring the support 26 relative to the axis 38 of the axle 28. The support 26 supports the calliper 14 relative to the axis 38 against deflection out of a plane of the disc 10 during application of the disc brake 12. Specifically, the arm 60 in combination with the pivot portion 36 and the fastener 44 combine to provide a support structure which supports the calliper 14 relative to the axis 38 against deflection out of the plane of the disc 10 during application of the disc brake 12. The support structure also allows linear movement between the calliper mounting bracket 54 and the anchor mounting bracket 30 to facilitate operation of the disc brake 12.

With reference to FIG. 7, the arm 60 and stops 48, 50 provide a sliding arrangement which provides lateral support to prevent deflection of the calliper 14 relative to the axis 38 out of the plane of the disc 10 during application of the disc brake 12. The sliding arrangement formed by the arm 60 and stops 48, 50 permits sliding of the calliper mounting bracket 54 in a longitudinal direction along the axis 38 relative to the anchor mounting bracket 30. This allows linear movement between the calliper mounting bracket 54 and the anchor mounting bracket 30 to facilitate normal operation of the disc brake 12, particularly as the calliper 14 must move during application of the brake.

When in an active condition, as shown in FIG. 7, the disc brake calliper support 26 operates by way of the arm 60 being located between the stops 48, 50, with the stops 48, 50 abutting either side of the arm 60 to resist deflection of the calliper 14. The stops 48, 50 may be mounted so as to be able to rotate relative to the pivot portion 36 to facilitate sliding of the arm 60 between the stops 48, 50 as the disc brake 12 is applied.

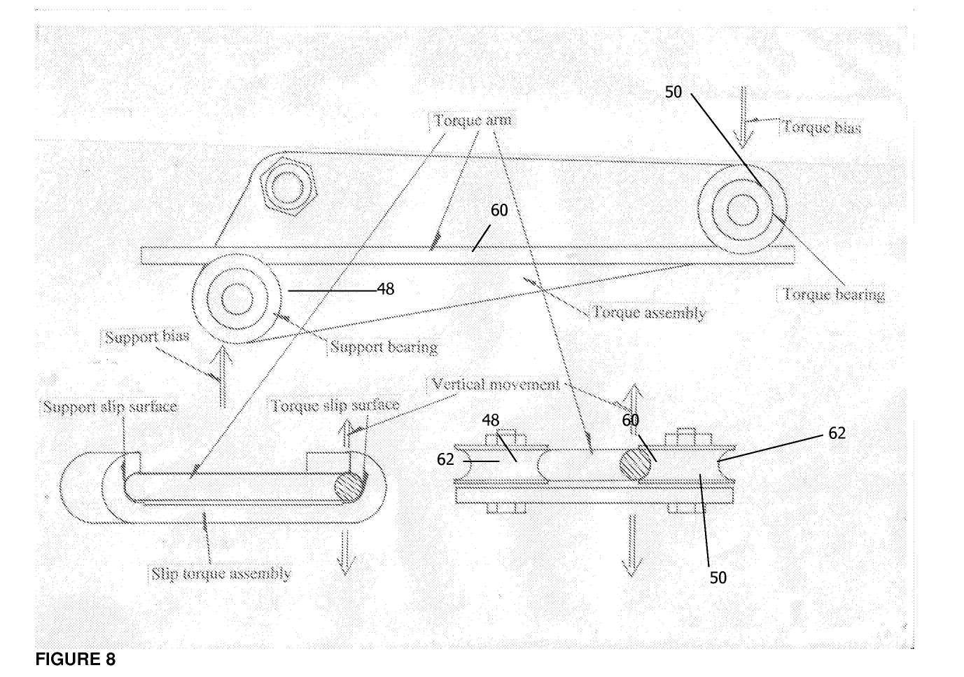

With reference to FIG. 8, each of the stops 48, 50 may have a profiled rolling surface 62, and the arm 60 may have a corresponding profile so as to positively locate relative to the stops 48, 50 to restrict movement of the arm 60 away from the profiled rolling surfaces 62.

Advantageously, preload bias applied by elastically bending the arm 60 may be adjusted by operation of the fastener 44 to pivot the pivot portion 36 and thus change the location of the stops 48, 50. The arm 60 may also be shaped so as to automatically change the amount of preload bias during operation of the disc brake 12.

The profile rolling surfaces can be changed for two profile slip surfaces for the same outcome at a cheaper cost of production, if required.

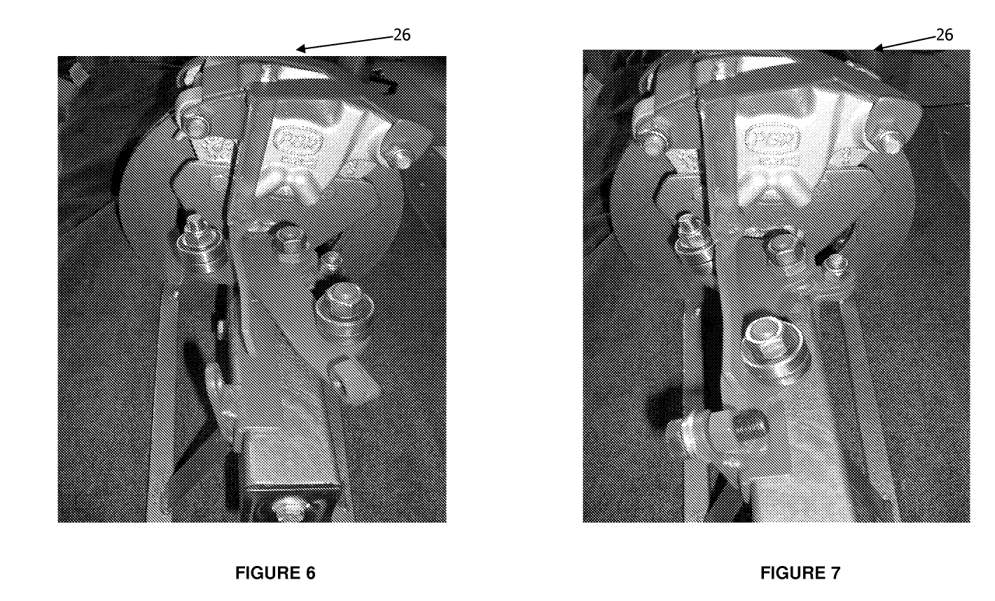

As shown in FIG. 6, the fastener 44 which forms part of the adjustment mechanism may be operated to a release condition in which the calliper mounting bracket 54 is released from the anchor mounting bracket 30 to facilitate servicing of the disc brake calliper 14.

FIG. 9 shows a disc brake calliper support 26 in accordance with an alternative example of the present invention, and like features are designated with like reference numerals. A substantial difference between the disc brake calliper support 26 shown in FIG. 9 and the disc brake calliper support 26 shown in FIGS. 5b to 8 resides in the arm 60 being coupled to the anchor mounting bracket 30 by way of a preload bias adjustment arm 64 which has a threaded connection 66 to adjust the bias, however this operates in a similar way to the fastener 44 of the earlier example. Otherwise, operation of the brake calliper support 26 shown in FIG. 9 is similar in that the preload bias acts in a sense opposite to deflection of the calliper 14 during operation of the disc brake 12.

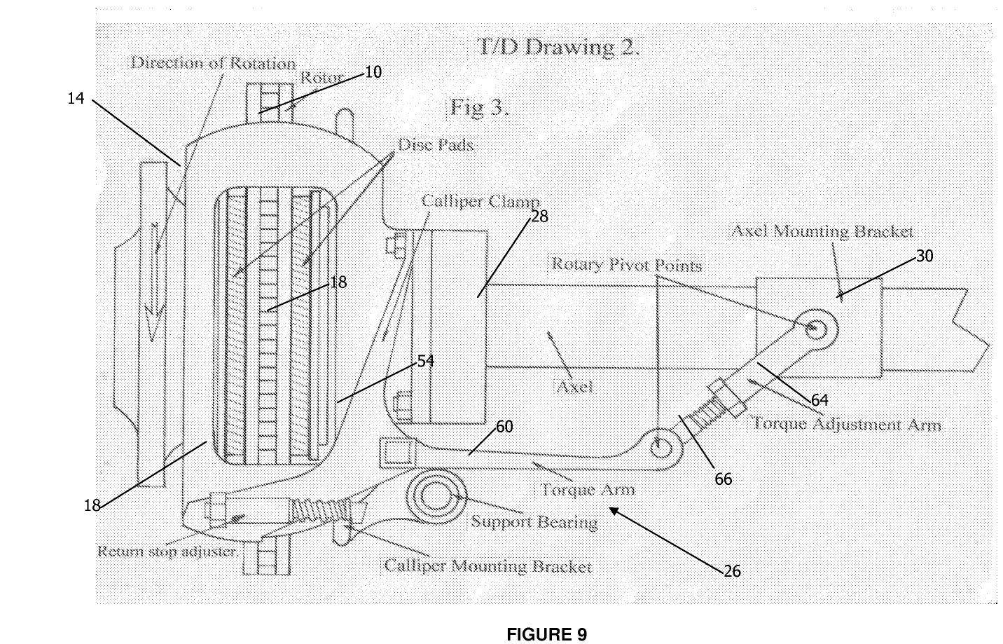

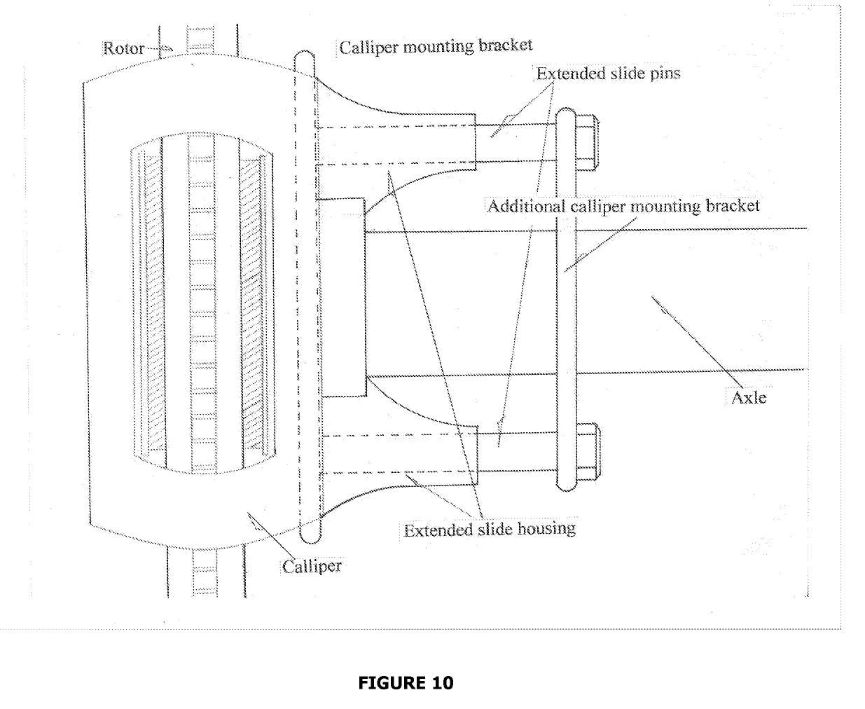

With reference to FIG. 10, in accordance with a further alternative example of the present invention, there is provided a disc brake calliper support 26 which may be integrated as standard equipment on a vehicle. By elongating one or both slide housings 68 on the calliper 14 and then using longer slide pins 70 that extend to a second axle mounting bracket 72, the manufacturer can incorporate this technology in a simple cost-effective manner. The example shown in FIG. 10 does not generate a bias as do the previous examples. The disc brake calliper support 26 does however stabilise the calliper 14 and ensures that it operates as it is designed to do, without deflection out of the plane of the disc 10 during application of the disc brake 12. As with the previous examples, the disc brake calliper support 26 of this example ensures that the calliper 14 can only move along the axle 28 in exact alignment.

More specifically, a housing of the calliper 14 is extended on each side to form elongated guides which are able to run along the slide pins 70. The slide pins 70 are fixed in parallel to the axle 28 by virtue of calliper mounting brackets which are fixed relative to the axle 28 at opposite end portions of the slide pins 70.

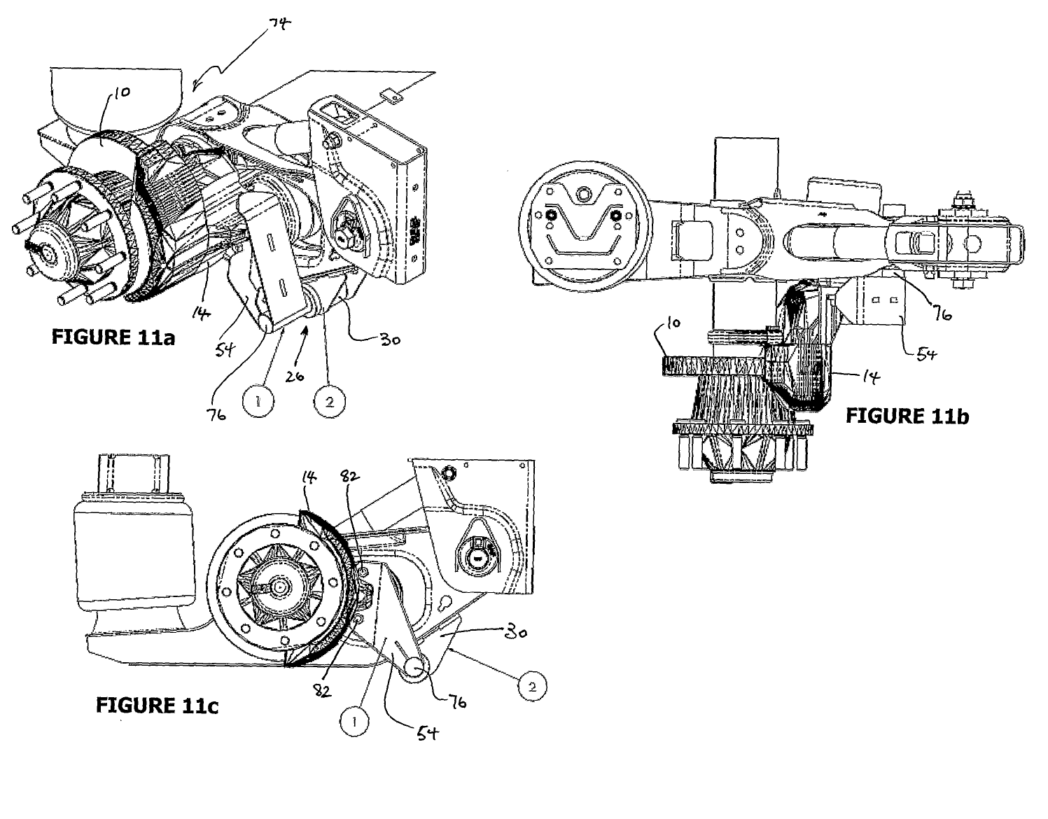

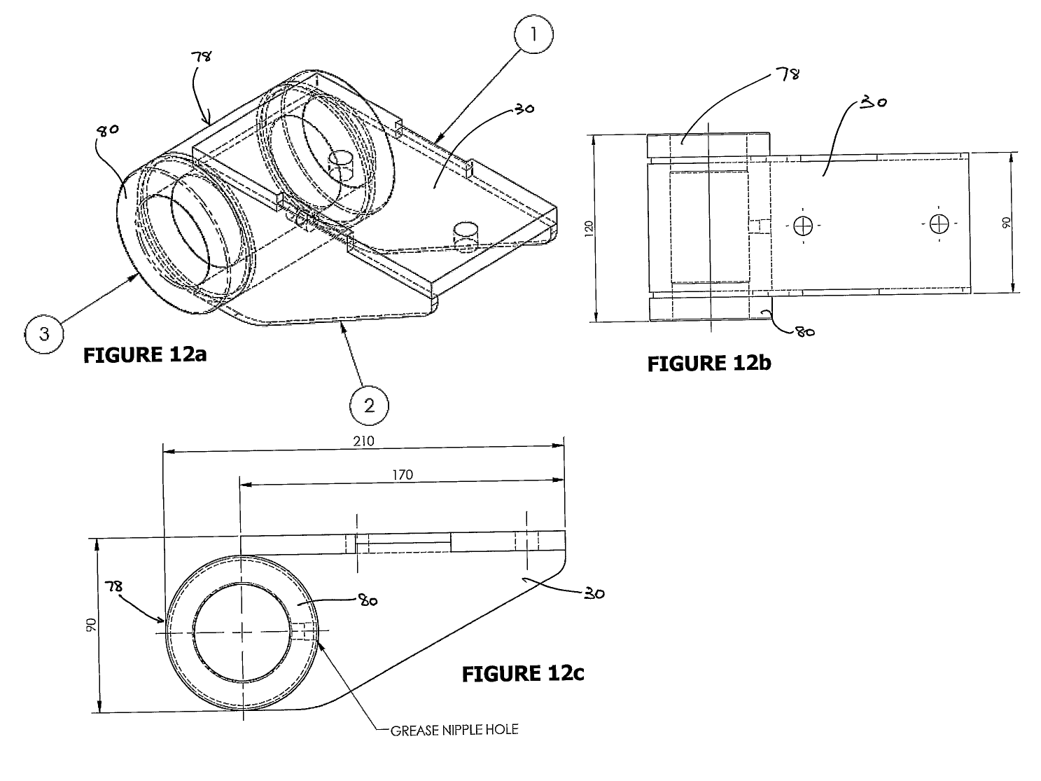

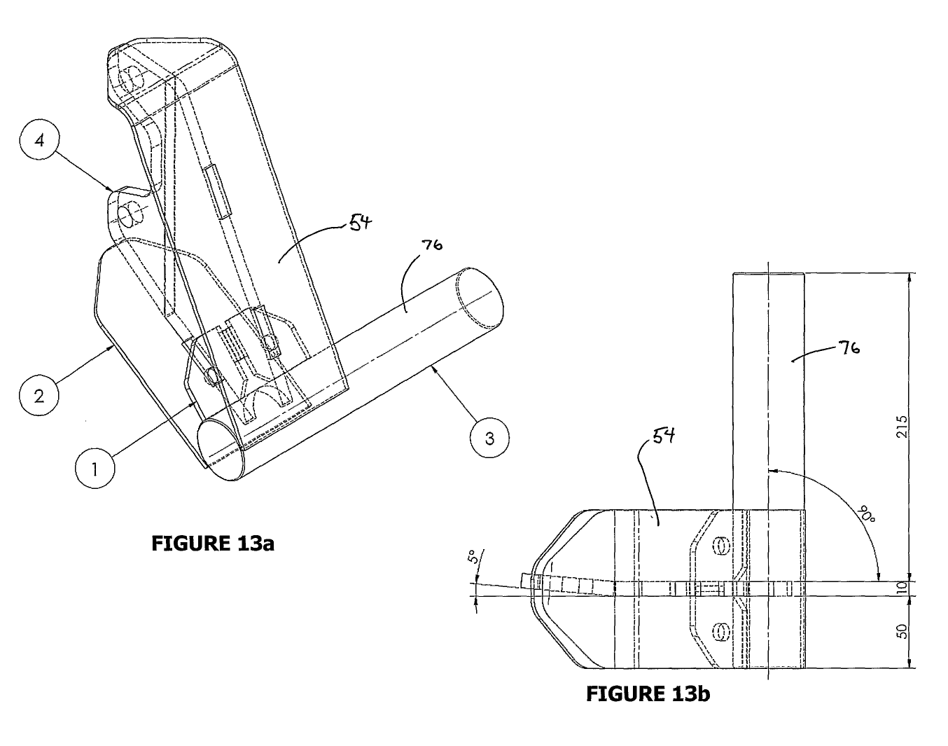

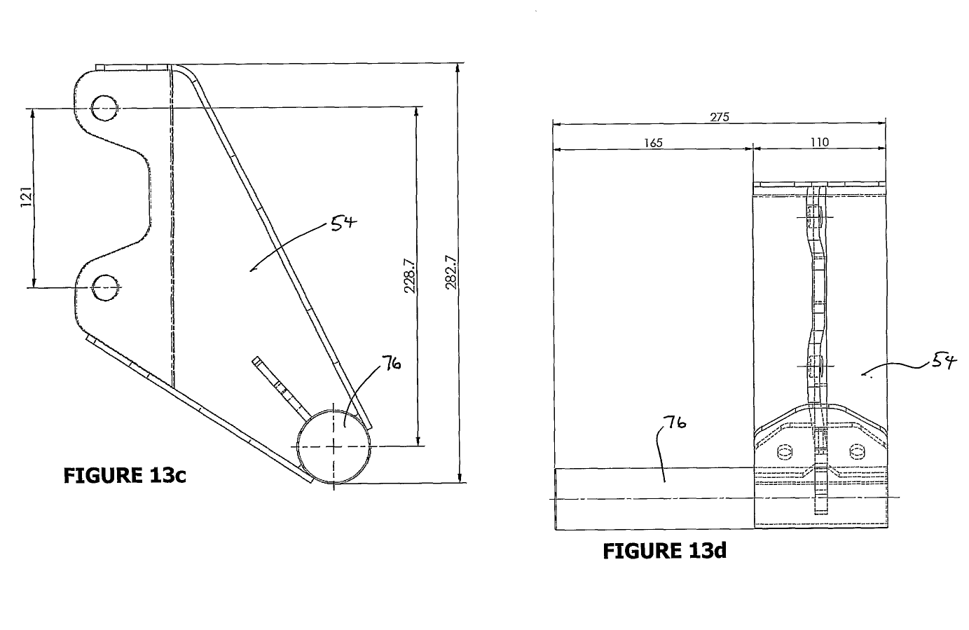

FIGS. 11 to 13 show an alternative example of the present invention in which the disc brake calliper support 26 takes the form of a two piece assembly which is able to be fitted simply and conveniently to an existing disc brake arrangement 74 on a vehicle. More particularly, the disc brake calliper support 26 includes a first part in the form of a calliper mounting bracket 54 and a second part in the form of an anchor mounting bracket 30. The calliper mounting bracket 54 includes a guide member in the form of a pin 76 which extends substantially parallel to the axis about which the disc 10 rotates, and the anchor mounting bracket 30 includes a sliding member 78 arranged to slide along a length of the pin 76. As can be seen, the sliding member 78 is in the form of a guided annular component (or ring) 80 which is mounted about the pin 76 for longitudinal sliding along the length of the pin 76. FIGS. 12a to 12c show the anchor mounting bracket 30 in further detail, and FIGS. 13a to 13d show the calliper mounting bracket 54 in further detail.

As shown in FIGS. 11a to 11c, the anchor mounting bracket 30 is fastened to an existing suspension assembly which is fixed relative to the axis about which the disc 10 rotates. The calliper mounting bracket 54 is fastened to the calliper housing 14, and may be fastened thereto by way of bolts 82 which are fitted to existing holes on the calliper housing. The anchor mounting bracket 30 and the calliper mounting bracket 54 are configured such that the pin 76 is located radially further from the axis than is the calliper housing 14 from said axis, so as to provide a greater lever arm in opposing deflection of the calliper housing 14 out of the plane of the disc 10. Preferably, the calliper mounting bracket 54 and the anchor mounting bracket 30 are configured such that the pin 76 is located to one side of a central plane which is coincident with the axis and which bisects the calliper housing 14. In this way, the pin 76 is spaced from a centre of deflection so as to improve effectiveness in opposing deflection of the calliper housing 14 out of the plane of the disc 10.

Advantageously, disc brake calliper supports 26 in accordance with examples of the invention are able to prevent or at least reduce premature wear of braking components of disc brake systems in many applications (including heavy vehicles, cars, motorcycles, etc.) and it is foreseen that use of the invention may result in maintenance savings and more widespread use of disc brakes.

While an example of the present invention has been described above, it should be understood that it has been presented by way of example only, and not by way of limitation. It will be apparent to a person skilled in the relevant art that various changes in form and detail can be made therein without departing from the spirit and scope of the invention. Thus, the present invention should not be limited by the above described examples.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A disc brake calliper support including a calliper mounting for coupling the support relative to a disc brake calliper, an anchor mounting for anchoring the support relative to an axis about which the disc rotates, and a support structure between the calliper mounting and the anchor mounting, wherein the support structure is adapted to support the calliper relative to the axis against deflection out of a plane of the disc during application of the disc brake, and wherein the support structure allows linear movement between the calliper mounting and the anchor mounting to facilitate operation of the disc brake.

2. A disc brake calliper support as claimed in claim 1, wherein the calliper mounting is in the form of a calliper mounting bracket which is fastened to the calliper at a plurality of locations on the calliper.

3. A disc brake calliper support as claimed in claim 2, wherein the calliper mounting bracket includes a pair of apertures for fastening to a pair of bolts at the rear of the calliper.

4. A disc brake calliper support as claimed in claim 1, wherein the anchor mounting is adapted for securing the support relative to an axle associated with the disc brake.

5. A disc brake calliper support as claimed in claim 4, wherein the disc brake calliper is for braking a wheel of a vehicle, and the anchor mounting is adapted for securing the support relative to an axle of the wheel.

6. A disc brake calliper support as claimed in claim 4, wherein the anchor mounting includes an anchor mounting bracket for fixing relative to the axle.

7. A disc brake calliper support as claimed in claim 1, wherein the support structure includes a sliding arrangement which provides lateral support to prevent said deflection of the calliper relative to the axis out of the plane of the disc during application of the disc brake, and wherein the sliding arrangement permits longitudinal sliding of the calliper mounting relative to the anchor mounting to allow said linear movement between the calliper mounting and the anchor mounting to facilitate operation of the disc brake.

8. A disc brake calliper support as claimed in claim 1, wherein the calliper mounting bracket includes a guide member extending substantially parallel to said axis about which the disc rotates, and the anchor mounting bracket includes a sliding member arranged to slide along a length of the guide member.

9. A disc brake calliper support as claimed in claim 8, wherein the guide member is in the form of a pin and the sliding member is in the form of a guided ring mounted about the pin.

10. A disc brake calliper support as claimed in claim 8, wherein the anchor mounting bracket is fastened to a suspension assembly which is fixed relative to the axis.

11. A disc brake calliper support as claimed in claim 9, wherein the pin is located radially further from the axis than is the calliper housing from said axis.

12. A disc brake calliper support as claimed in claim 9, wherein the pin is located to one side of a central plane which is coincident with the axis and which bisects the calliper housing.

13. A disc brake calliper support as claimed in claim 7, wherein the support structure includes an arm fixed to the calliper mounting, and a pair of stops fitted to the anchor mounting and spaced in the direction of the axis, arranged such that in use the arm is located between the stops with the stops abutting either side of the arm to resist said deflection of the calliper.

14. A disc brake calliper support as claimed in claim 13, wherein the stops are provided with bearings to facilitate rolling of the stops along the arm to facilitate sliding movement of the calliper mounting relative to the anchor mounting during operation of the disc brake.

15. A disc brake calliper support as claimed in claim 13, when dependent on claim 6, wherein the stops are rotationally mounted to a pivot portion of the anchor mounting, and the pivot portion is pivotally mounted to the anchor mounting bracket.

16. A disk brake calliper support as claimed in claim 14, wherein each of the stops has a profiled rolling surface, and the arm is correspondingly profiled to restrict movement of the arm away from the rolling surface.

17. A disc brake calliper support as claimed in claim 1, wherein the support provides a preload bias to the calliper mounting in an opposite sense to said deflection.

18. A disk brake calliper support as claimed in claim 17, wherein the preload bias is applied by elastically bending the arm by adjusting the location of the stops.

19. A disk brake calliper support as claimed in claim 18, wherein the location of the stops is adjusted by pivoting the pivot portion relative to the anchor mounting bracket.

20. A disc brake calliper support as claimed in claim 17, wherein the support provides adjustment of the preload bias.

21. A disc brake calliper support as claimed in claim 20, wherein the support is adjustable by operation of an adjustment mechanism which is operable to a release condition in which the calliper mounting is released from the anchor mounting to facilitate servicing of the disk brake calliper.

22. A disk brake calliper support as claimed in claim 21, wherein the adjustment mechanism is in the form of a threaded fastener which is adjustable for tightening a connection between the anchor mounting bracket and the pivot portion.
